(19) United States
(12) Patent Application Publication
(10) Pub. No.: US 2021/0318591 A1
(43) Pub. Date: Oct. 14, 2021

(54) MID-INFRARED OPTICAL FREQUENCY COMB GENERATION SYSTEM AND METHOD BASED ON MANIPULATION OF MULTI-PHOTON ABSORPTION EFFECT

(71) Applicant: Xi'an Institute of Optics and Precision Mechanics, Chinese Academy of Sciences, Xi'an (CN)

(72) Inventors: Leiran WANG, Xi'an (CN); Qibing SUN, Xi'an (CN); Weichen FAN, Xi'an (CN); Wenfu ZHANG, Xi'an (CN); Wei ZHAO, Xi'an (CN)

(21) Appl. No.: 17/039,942

(22) Filed: Sep. 30, 2020

(30) Foreign Application Priority Data
Apr. 10, 2020 (CN) 202010280628.7

(51) Int. Cl. G02F 1/35

(52) U.S. Cl. CPC G02F 1/3536; G02F 1/3501; G02F 2203/15; G02F 2203/17; G02F 2001/3509; G02F 2203/11

(57) ABSTRACT

The present application relates to a mid-infrared (MIR) optical frequency comb (OFC) generation system and method based on manipulation of the multi-photon absorption (MPA) effect, which can break through the repetition-rate limitation for traditional systems and restricted bandwidth as well as high dependence on high-performance pump sources for microcavity-based frequency combs. The system includes a pump light source unit for providing a pump laser, a microring resonator (MRR) unit for broadband comb generation through nonlinear four-wave-mixing process, and an MPA effect control unit for realizing the MIR soliton-state OFC by controlling the loaded voltage or current on the MRR unit. The proposed system and operation method have advantages of being simple in structure, economic for use, and easy to implement for broadband low-noise frequency comb generation.

### FIELD

The present application relates to a mid-infrared optical frequency comb generation system and method, in particular to a mid-infrared soliton-state optical frequency comb generation system and method based on manipulation of the multi-photon absorption effect.

### BACKGROUND

The mid-infrared (MIR) wavelength region is not only an atmospheric window with minimum attenuation, but also a main radiation band for heat sources such as airplanes and tanks. Meanwhile, the MIR region covers multiple absorption peaks for many different kinds of atoms and molecules. Therefore, it shows unique advantages in defense technology, medical treatment, communication system and other applications.

The key to wide applications of MIR lasers lies on the realization of high-quality light sources, especially broadband multi-wavelength coherent sources. An optical frequency comb (OFC) which is composed of discrete and equally-spaced optical frequency components, can act as an excellent multi-wavelength source with high fineness. And the invention of OFCs has been regarded as a cornerstone in laser and metering technologies, already playing important roles in areas of coherent communication, precision measurement, etc. However, traditional MIR OFCs were always built on ZBLAN fluoride optical fibers or specially-doped semiconductor materials through the mode-locking technique. Therefore, such systems generally suffer from complicated structure, big size, large weight and high cost, which seriously limit their practical applications. Besides, due to the difficulty of waveguide dispersion control and strict limitation of physical cavity length, it was rather hard to achieve OFCs with large bandwidth and high repetition rates.

Thanks to rapid development of micro/nano fabrication technologies, now it becomes possible to make microring resonator (MRR) chips with high quality (Q) factors via advanced thin-film growth and ultra-fine etching processes, paving a new way towards integrated OFCs. High-Q MRRs with low mode volume can enhance intracavity optical fields by 6-8 orders of magnitude higher, and hence significantly improve the nonlinear optical effects. Meanwhile, they naturally benefit from unprecedented advantages of small size, low power consumption, high repetition rate, and so on. While in practice the noise of MRR-based OFCs should be low, that is, the mode-locked soliton state is desired. Usually; this requires a high-power narrow-linewidth laser with ultrahigh frequency-sweeping speed, to scan repeatedly around the resonant frequency of an MRR. However, the performance of pump sources in the MIR region is much lower than those in other wavelengths, resulting in difficult generation for MIR soliton-state frequency combs in microcavities. Above problems combined together severely hinder practical applications and future developments of the MIR OFCs.

### SUMMARY

The present application aims at providing a mid-infrared (MIR) soliton-state optical frequency comb (OFC) generation system and method based on manipulation of the multi-photon absorption (MPA) effect, which can break through the bandwidth and repetition-rate limitations for traditional OFC systems, as well as release the strong demand on high-performance pump sources. Such system is capable of realizing an MIR soliton frequency comb with ultra-broad bandwidth, high repetition-rate and low threshold, offering a novel method to facilitate practical uses of MIR OFCs along with important research significance and application value.

The technical solution of the present application provides an MIR soliton-state generation system based on manipulation of the MPA effect; including a pump light source unit, a microring resonator (MRR) unit and an MPA effect control unit;

the pump light source unit is used for providing a pump laser;

the MRR unit is used for receiving the pump laser, and producing an MIR broadband OFC through the nonlinear four-wave-mixing process;

the MPA effect control unit is used for controlling the MPA effect by varying the density of free carriers in the MRR unit, to enable the output of MIR soliton-state

Further, the pump light source unit includes an MIR narrow-linewidth tunable continuous-wave (c.w.) laser source and a microscope objective; the MIR narrow-linewidth tunable c.w. laser source is used for emitting the pump laser; and the microscope objective is used for compressing the mode size of the pump laser and then input to the MRR unit.

Further, the MRR unit includes an MRR cavity and a ring-shaped metal electrode; a P-type doping area and an N-type doping area are arranged on two sides of the MRR. cavity, and the ring-shaped metal electrode is connected with the P- and N-type doping area.

Concerning microcavity-based OFCs, the employed material needs to own both high refractive index and nonlinear coefficient in its transparent wavelength range; and at present the Group-IV material of silicon is mostly adopted for the MIR region. However, silicon usually suffers from large linear loss, MPA effect and other problems in this wavelength range. In traditional approaches the MPA effect should be always inhibited to avoid excessive intracavity loss, which leads to relatively high power threshold and limited bandwidth of the emitted OFC. In the present application, germanium is selected as the fabrication material for the MRR cavity in order to reduce the linear propagation loss. The Group-IV germanium material possesses excellent optical properties in the MIR region, e.g., low (non-)linear loss in the wavelength range of 2-10 atm together with very strong third-order nonlinear coefficient, which can simultaneously meet the requirements for low pump threshold, high conversion efficiency; ultra-broad bandwidth, etc.

Further, in order to precisely control the lifetime (or namely, the density) of free carriers, the MPA effect control unit is an arbitrary waveform generator (AFG), and the AFG is connected with the ring-type metal electrodes of the MRR unit.

Further, in order to real-time monitor the waveform output from the NUR unit, the system further includes a waveform monitoring device; the light wave output from the MRR unit is first collimated by a collimating lens and then injected to the waveform monitoring device.

Further, the waveform monitoring device is an optical spectrum analyzer.

The present application further provides a method for realizing an MIR soliton-state frequency comb by an MIR OFC generation system based on manipulation of the MPA effect, including the following steps:

Step 1, adjusting the pump laser emitted from the MIR narrow-linewidth tunable c.w. laser source, so as to ensure its intensity and polarization meeting the power threshold and phase matching condition for the four-wave-mixing process;

Step 2, compressing the mode size of the pump laser by a microscope objective and injecting the pump laser to the MRR unit to generate the four-wave mixing process;

Step 3, tuning the central wavelength of pump laser to be close and (slightly) larger than the resonant wavelength of the MRR unit; at the same time, manipulating the MPA effect control unit by decreasing the free carrier density of the NUR unit to reduce the MPA effect, until multiple comb teeth begin to generate at this stage; and

Step 4, keeping the central wavelength of pump laser fixed; and re-manipulating the MPA effect control unit by increasing the free carrier density of the MRR unit to enhance the MPA effect, until stable broadband soliton-state OFC can be obtained in the MIR region.

Further, in Step 3, the MPA effect control unit is an AFG; by increasing output voltage or current of the AFG, the free carrier density of the MRR unit is decreased and the MPA effect is reduced.

Further, in Step 4, the MPA effect control unit is an AFG; by decreasing the output voltage or current of the AFG, the free carrier density of the MRR unit and the MPA effect are enhanced.

The present application has the following advantages:

1. The present application adopts the method of manipulating the MPA effect in the MRR to solve the loss increasing problem arisen from the MPA process, which is capable of achieving broadband soliton-state OFC with ultra-high repetition rate, low threshold and noise in the MIR region. The pump threshold is less than 18 mW, the spectral bandwidth is larger than 3000 nm, and the repetition rate is higher than 150 GHz which is increased by 2-3 orders of magnitude compared to those using traditional approaches.

2. The present application only needs slowly tuning the pump wavelength and controlling loaded voltage or current of the MRR to generate stable MIR soliton-state OFC, acting as a simple and easy method in practice, by releasing the strong dependence on high-performance fast-sweeping pump sources as well as avoiding complicated tuning procedures for other methods.

3. The present application uses germanium, which has relatively lower linear- and nonlinear loss in the wavelength range of 2-10 μm compared with silicon, as the MRR cavity material to realize low-threshold MIR OFC with high integrability and repetition rate. Equally important, the very strong third-order nonlinear coefficient of germanium can well meet the requirements for more efficient conversion with larger band width at lower threshold.

4. The present application benefits from the high nonlinear coefficient and low power threshold feature, and significantly improves the operation efficiency of the MIR OFC system.

5. The present application is simple in structure, convenient for use, easy to integrate and low in cost, as well as takes the advantage of broad bandwidth, low noise, high reliability and so on.

### BRIEF DESCRIPTION OF THE DRAWINGS

FIG. 1 is a schematic diagram of the system structure in an embodiment of the present application;

FIG. 2 is a schematic diagram of a germanium microring resonator (MRR) cavity in an embodiment of the present application;

FIG. 3a is a spectral result for the modulation-instability state without control on the loading voltage of the electrode;

FIG. 3b is a spectral result for the generated unstable mid-infrared (MIR) optical frequency comb (OFC) when the loading voltage of the electrode is increased; and

FIG. 3c is a spectral result for the generated low-noise soliton-state OR; when the loading voltage of the electrode is reduced.

The reference numbers in the figures are as follows: 1—MIR narrow-linewidth tunable continuous-wave (c.w.) laser source, 2—microscope objective; 3—MRR unit, 31—MRR cavity, 32—silicon substrate. 33—P-type doping area, 34—N-type doping area, 35—ring-shaped metal electrode, 4—collimating lens; 5—optical spectrum analyzer, and 6—arbitrary waveform generator (AFG).

### DETAILED DESCRIPTION OF THE EMBODIMENTS

The present application will be further described below in conjunction with the drawings and specific embodiments.

An embodiment provides a mid-infrared (MIR) soliton-state optical frequency comb (OFC) generation system based on a microring resonator (MRR), including a pump light source unit for providing a pump laser, an MRR unit for generating the nonlinear four-wave-mixing process; a multi-photon absorption (MPA) effect control unit for manipulating the lifetime (or namely, the density) of free carriers in the MRR unit and a waveform monitoring device for monitoring the output of the MRR unit. The waveform monitoring device used by the embodiment is an optical spectrum analyzer. It can be seen from the drawing, that the output of the MRR unit enters the optical spectrum analyzer 5 through a collimating lens 4. In other embodiments, a time-domain analyzing device, such as a broadband oscilloscope together with a high-speed photoelectric detector and the like; may also be used. However, the system does not rely on such device. Thus, in other embodiments, such device may not be used, and the output of the MRR unit can be directly judged according to the spectral characteristics of light waves.

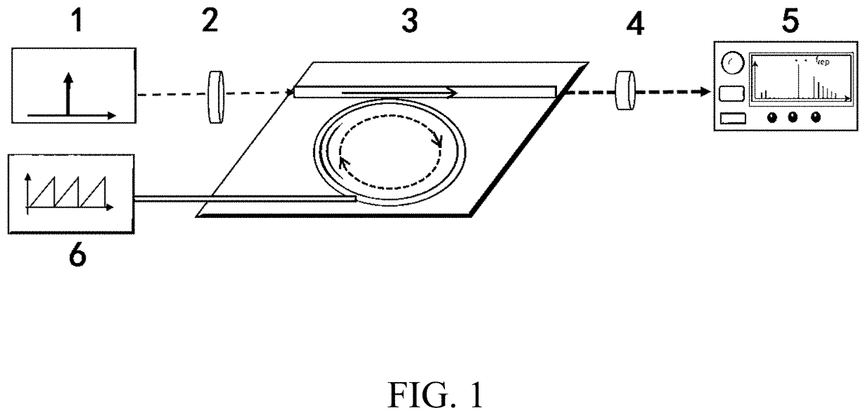

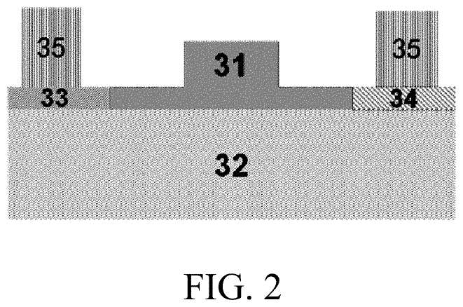

As shown in FIG. 1, the pump light source unit in this embodiment includes an MIR narrow-linewidth tunable continuous-wave (c.w.) laser source 1 and a microscope objective 2. By combining with FIG. 2, in this embodiment, the MRR unit 3 includes an MRR cavity 31 composed of a germanium waveguide, a silicon substrate 32 for confining the optical field, a P-type doping area 33 and an N-type doping area 34 for loading voltage, and a ring-shaped metal electrode 35 for connecting with an MPA effect control unit; and in other embodiments, the substrate material in other forms may also be used, as long as the material refractive index is less than that of germanium. The MRR cavity made of other materials may also be used, as long as the materials have the MPA effect, such as the normally-used silicon material. The MPA effect control unit is an arbitrary waveform generator (AFG) 6, and its output is connected with the ring-shaped metal electrode 35 in the MRR unit 3. The output of the AFG 6 may be voltage or current type. In other embodiments, other current or voltage sources with fast tunable ability may also be used as the MPA effect control unit for stable voltage or current output.

Specifically, the MIR soliton-state OFC may be generated by the following process:

1) Adjusting the MIR narrow-linewidth tunable c.w. laser source 1, to ensure the power and polarization of the pump laser emitted by the laser source meeting the intensity threshold and phase matching condition for four-wave-mixing process; and regulating the microscope objective 2 to compress the mode size of pump laser to minimum and then inject to the MRR unit 3 for the four-wave mixing process.

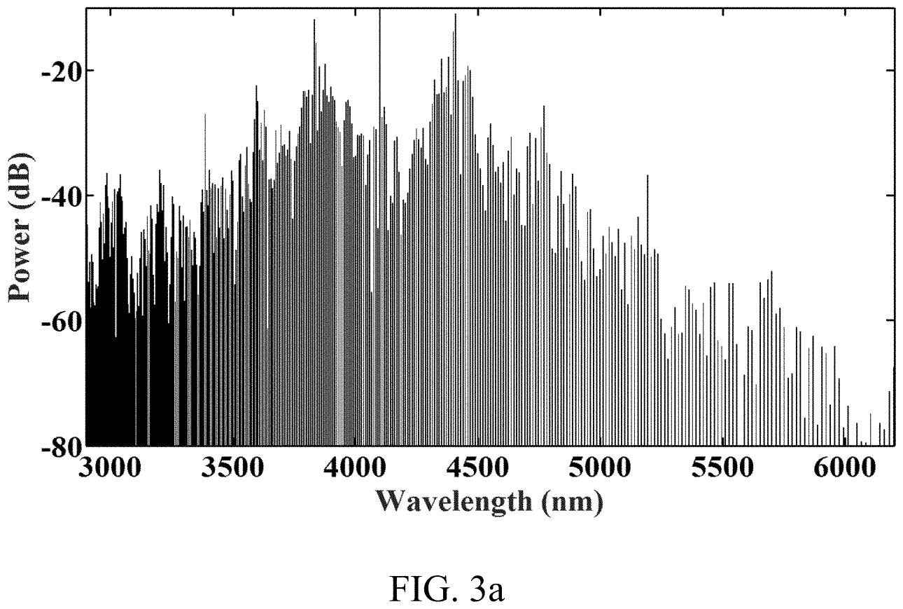

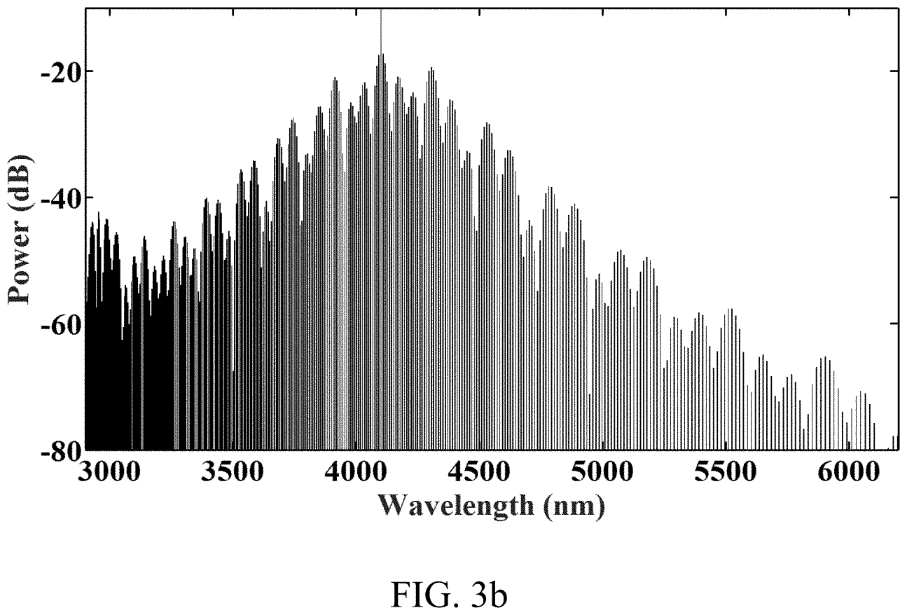

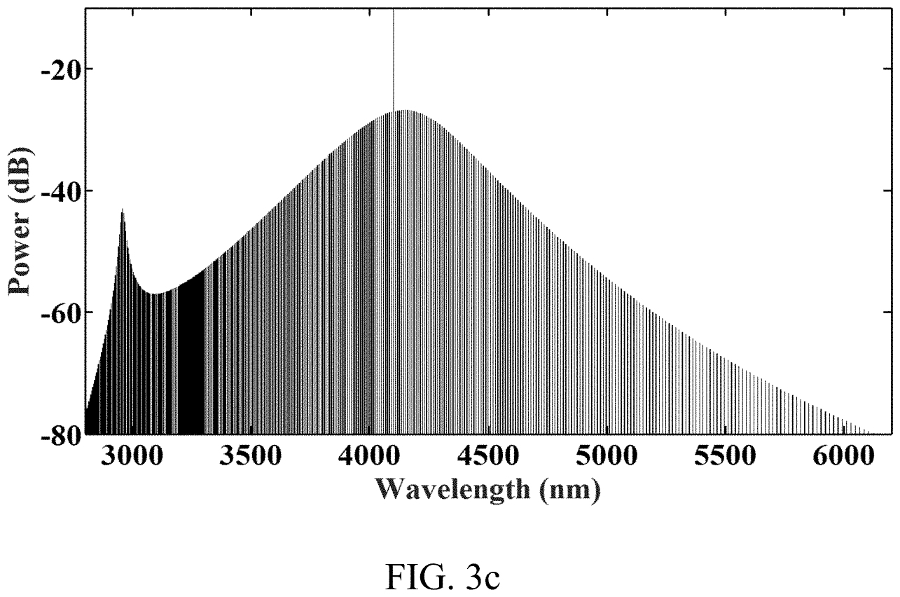

2) Tuning the MIR narrow-linewidth tunable c.w. laser source 1 to make its central wavelength first be close while slightly less, and then gradually enlarged to be close but slightly larger than the resonant wavelength of the MRR cavity 31; wherein for a specific tuning process, the central wavelength of pump laser is slowly increased from the peak to half-peak of the MRR transmission spectrum, at this stage the display on the optical spectrum analyzer is as shown in FIG. 3a; subsequently, adjusting the AFG 6 to enable the loaded voltage or current on the ring-shaped metal electrode 35 of the MRR unit to be at high level (typically, 10-20 V), in order to reduce the free carrier density of the MRR cavity 31 as well as the MPA effect for initial generation of multiple comb teeth in the MIR region, and at this stage the display on the optical spectrum analyzer is as shown in FIG. 3b.

3) Keeping the wavelength of the MIR narrow-linewidth tunable c.w. laser source 1 unchanged, reducing the output voltage of the AFG 6, wherein typically it should be reduced by more than one half of original level (e.g., to 0-5 V), in order to enhance the intracavity free carrier density as well as the MPA effect for complete generation of soliton-state MRR-based OFC in the MIR region, and at this stage the display on the optical spectrum analyzer is as shown in FIG. 3c.

The working principle of the present application is as follows:

At first, the narrow-linewidth tunable c.w. laser source 1 is used as the pump light of the MRR cavity after power amplification; the microscope objective 2 is used for compressing mode size of the pump laser to minimum and then injecting to the MRR. cavity 31, the central wavelength of the narrow-linewidth tunable c.w. laser source 1 is first set to be close while slightly less, and then slowly increased to be slightly larger than the resonant wavelength of the MRR cavity 31 (referring to FIG. 3a, which is a spectral result for the modulation-instability state without control on the loaded voltage of the electrode); next, rising output voltage or current of the AFG 6 to trigger initial generation of multiple comb teeth in the MIR region (referring to FIG. 3b, which is a spectral result for the generated unstable MIR OFC when the loading voltage of the electrode is increased); after that, reducing the output voltage of the AFG 6 in order to enhance the intracavity free carrier density as well as the MPA effect, and then complete generation of the MIR broadband low-noise soliton comb can be realized (referring to FIG. 3c, which is a spectral result for the generated low-noise soliton-state OFC when the loading voltage of the electrode is reduced).

Referring to FIGS. 3a, 3b and 3c, the result for the MIR soliton-state OFC generation by manipulating the MPA effect. The present application uses the method of manipulating the MPA effect in Group-IV material MRRs, and can achieve dynamic balance of intracavity field by controlling the free carrier density via adjusting the loading voltage of the MRR. It successfully solves the difficult generation problem for MRR-based soliton frequency combs in the MIR region, being capable of emitting the low-noise ultra-broad soliton-state OFC with a smooth hyperbolic-secant spectral profile and a bandwidth of more than 3000 nm (over an octave). The present application adopts the germanium with extremely strong nonlinear effect as the MRR cavity material, and can realize highly-integrated MIR OFC with a low pump threshold of 18 mW and an ultra-high repetition rate of more than 150 GHz. The employed method only needs slowly tuning of pump wavelength to achieve the soliton-state OFC without the requirement for high-performance fast-sweeping sources, having advantages of being simple in structure, economic for use, and high in reliability. This method is also a universal approach, which is suitable for all those materials with the MPA effect in the MIR region such as germanium and silicon.

1. A mid-infrared (MIR) optical frequency comb (OFC) generation system, comprising:
a pump light source unit, a microring resonator (MRR) unit, and an arbitrary waveform generator;
wherein, during operation,
the pump light source unit inputs a pump laser to the MRR unit,
the arbitrary waveform generator inputs a current signal or a voltage signal to the MRR unit and varies a density of free carriers in the MRR unit, and
the MRR unit outputs a MIR soliton-state OFC.

2. The MIR OFC generation system according to claim 1, wherein the pump light source unit comprises an MIR narrow-linewidth tunable continuous-wave (c.w.) laser source configured to emit the pump laser and a microscope objective for compressing a mode size of the pump laser.

3. The MIR OFC generation system according to claim 1, wherein the MRR unit comprises an MRR cavity, a ring-shaped metal electrode, a P-type doping area and an N-type doping area that are spaced away from each other and connected by the ring-shaped metal electrode.

4. The MIR OFC generation system according to claim 3, wherein the MRR cavity (31) is made of germanium.

5. (canceled)

6. The MIR OFC generation system according to claim 5, further comprising a waveform monitoring device for monitoring spectral waveform outputted by the MRR unit.

7. The MIR OFC generation system according to claim 6, wherein, the waveform monitoring device is an optical spectrum analyzer.

8-9. (canceled)

10. The MIR OFC generation system according to claim 1, wherein, the arbitrary frequency generator is electrically connected with the ring-shaped metal electrode in the MRR cavity unit.

11-12. (canceled)

13. A method for generating a mid-infrared (MIR) optical frequency comb (OFC) generation by the MIR OFC generation system of claim 1, comprising:
emitting the pump laser from an MIR narrow-linewidth tunable continuous-wave (c.w.) laser source disposed in the pump light source unit;
adjusting an intensity and a polarization of the pump laser to satisfy a power threshold and a phase matching condition for a four-wave-mixing process;
compressing a mode size of the pump laser using a microscope objective and injecting the pump laser to the MRR unit to generate the four-wave-mixing process;
tuning a central wavelength of the pump laser to a value larger than a resonant wavelength of the MRR unit;
sending the voltage signal or the current signal generated in the arbitrary frequency generator to the MRR unit to decrease the free carrier density of the MRR unit until multiple comb teeth begin to appear;
keeping the central wavelength of pump laser constant; and
adjusting the arbitrary frequency generator to increase the free carrier density of the MRR unit until the MIR broadband soliton-state OFC is stable.

14. The method for implementing generation of the MIR OFC according to claim 13, wherein the free carrier density of the MRR unit is decreased by increasing the voltage signal or the current signal outputted from the arbitrary waveform generator.

15. The method for implementing generation of the MIR OFC according to claim 14, wherein the free carrier density of the MRR unit is increased by decreasing the voltage signal or the current signal outputted from the arbitrary waveform generator.
